(19) United States
(12) Patent Application Publication
(10) Pub. No.: US 2025/0050280 A1
(43) Pub. Date: Feb. 13, 2025

(54) SEALING METHOD FOR THE SEALING OF A METAL SLEEVE TO AN INORGANIC MEMBRANE, SEALED INORGANIC MEMBRANE, AND USE OF A SEALED INORGANIC MEMBRANE

(71) Applicant: TECHNISCHE UNIVERSITEIT EINDHOVEN, Eindhoven (NL)

(72) Inventors: Arash RAHIMALIMAMAGHANI, Eindhoven (NL); Erik VAN HERK, Eindhoven (NL); Fausto GALLUCCI, Eindhoven (NL)

(21) Appl. No.: 18/720,489

(22) PCT Filed: Dec. 16, 2022
(86) PCT No.: PCT/NL2022/050725

§ 371 Date: Jun. 14, 2024

(30) Foreign Application Priority Data
Dec. 17, 2021 (NL) 2030179

(51) Int. Cl. B01D 65/00; B01D 53/22

(52) U.S. Cl. CPC B01D 65/003; B01D 53/228; B01D 2313/04

(57) ABSTRACT

In a first aspect, the invention relates to a sealing method for the sealing of a metal sleeve to an inorganic membrane, said method comprising the steps of providing a metallic sleeve to cover at least part of the inorganic membrane, and applying graphite tape onto at least part of the inorganic membrane to create a graphite sleeve in between the inorganic membrane and the metallic sleeve. The present invention further relates to a sealed inorganic membrane, and to the use of a sealed inorganic membrane for a gas separation process in a membrane reactor or as a membrane reactor.

### FIELD OF THE INVENTION

The present invention relates to a sealing method for the sealing of a metal sleeve to an inorganic membrane. The present invention further relates to a sealed inorganic membrane. The present invention further relates to the use of a sealed inorganic membrane in a membrane reactor or as a membrane reactor.

### BACKGROUND

A membrane is a permeable phase, often in the form of a thin film, made of a variety of materials ranging from inorganic solids to different types of polymers. The main role of the membrane film is to control the exchange of materials between the two adjacent fluid phases. A membrane is able to act as a selective barrier, which separates different species either by sieving or by controlling their relative rate of transport through itself. Transport processes across the membrane are the result of a driving force, which is generally associated with a gradient of concentration, pressure, temperature, electric potential, etc.

A membrane reactor is a device that combines the separation properties of membranes with the typical characteristics of catalytic reaction steps in only one unit. In particular, the membrane does not only play the role as a separator but also as a part of the reactor itself. In other words, a membrane reactor is an engineering device that selectively removes a product from the reaction system, giving the possibility of achieving higher conversion than a traditional process under the same operation conditions.

Most of the progress in the membrane separation and membrane reactor areas has happened in the last twenty years mainly owing to the development of new membrane materials able, for example, to resist at high temperature, mechanical strength, and so on. In particular, inorganic membranes offer several advantages over organic membranes, because of their stability at a relatively high temperature (>373 K), and good chemical and mechanical resistances.

Inorganic membranes are commonly constituted by different materials such as ceramic, carbon, silica, zeolite, oxides (alumina, titania, zirconia) as well as palladium, silver and so forth, and their alloys. Inorganic membranes can be subdivided into porous and dense. Porous membranes can be classified according to their pore diameter into microporous, mesoporous and macroporous. Dense membranes can be categorized into supported and unsupported ones.

Development of inorganic membranes further has been broadened the application of membrane reactors and membrane separation processes in industries. Inorganic membranes could operate at high temperatures and pressures in which organic membranes fail to achieve high performance.

Sealing of inorganic membranes poses difficulties due to the mismatch of the thermal expansion coefficient (TEC) of the sealant and the membrane material, the mechanical resistance of the sealing at high pressures and temperatures, and the reaction of the sealing with the membrane material or with the reactants in the reactor.

Currently, the sealing for inorganic membranes is performed via glass sealing or so-called Swageloc™ connectors. Drawbacks of a glass sealing include that it cannot be used in the environments where the membrane material reacts with the glass sealing (such as perovskite membranes) or where the preparation of the membrane requires high temperature treatment, at higher temperatures than the melting point of the glass sealing. Furthermore, the low mechanical strength of glass sealing is a hurdle in up-scaling of the membranes for industrial usage due to the increase in size and the weight of the membrane. Swageloc™ connectors are the most common used sealing method in tubular membranes due to their resistance at high temperatures and pressures, high mechanical strength, and variety in types and sizes. The drawbacks in the Swageloc™ connectors include their high weight and bulkiness and high cost. The complexity in sealing ceramic supported inorganic membranes with Swageloc™ connectors and high price of the sealing is a hurdle in adapting this technology for industrial scale applications.

There is a need for a sealing method for inorganic membranes which is less complex and lower in costs, and will lead to a sealing that is flexible in size, resistance to high temperature and pressure, chemical stability, and high mechanical strength. This will enable the (often tubular) inorganic membranes such as palladium and carbon molecular sieve membranes (CMSM) to be implemented in industrial scales.

### OBJECTS

It is an object of the present invention to provide an improved sealing method for inorganic membranes.

It is a further object of the present invention to provide a sealing method that leads to sealed inorganic membranes that are robust, have high chemical resistance, are durable at high temperatures and pressures, and low-cost.

It is a further object of the present invention to provide a sealing method for inorganic membranes which is less complex and/or lower in costs, and will lead to a sealing that is flexible in size, resistance to high temperature and pressure, chemical stability, and/or high mechanical strength.

### STATEMENT OF THE INVENTION

In a first aspect, the invention relates to a sealing method for the sealing of a metal sleeve to an inorganic membrane, said method comprising the steps of
providing a metallic sleeve to cover at least part of the inorganic membrane, and
applying graphite tape onto at least part of the inorganic membrane to create a graphite sleeve in between the inorganic membrane and the metallic sleeve.

In a second aspect, the invention relates to a sealed inorganic membrane obtained or obtainable by the sealing method according to the first aspect.

In a third aspect, the invention relates to the use of the sealed inorganic membrane according to the second aspect in a membrane reactor or as a membrane reactor for a gas separation process for the separation of at least two gases, preferably the gases being selected from He, H₂O, Ne, H₂, NO, Ar, NH₃, N₂, O₂, CO, CO₂, CH₄, C₂H₄, C₂H₆, propene, propane, H₂S, methanol, ethanol, DME, 1-2 propanol and 1-2 butanol.

Corresponding embodiments of the sealing method according to the first aspect are also applicable for the sealed inorganic membrane according to the second aspect and for the use according to the third aspect.

One or more of the above mentioned objects are achieved by the sealing method according to first aspect of the invention, the sealed inorganic membrane according to the second aspect and/or the use of the sealed inorganic membrane according to third aspect.

### DETAILED DESCRIPTION

The present invention is elucidated below with a detailed description.

### BRIEF DESCRIPTION OF DRAWINGS

The present invention is described hereinafter with reference to the accompanying drawings in which embodiments of the present invention are shown and in which like reference numbers indicate the same or similar elements.

FIG. 1 shows an example of a Pd or CMS membrane and the graphite sleeve.

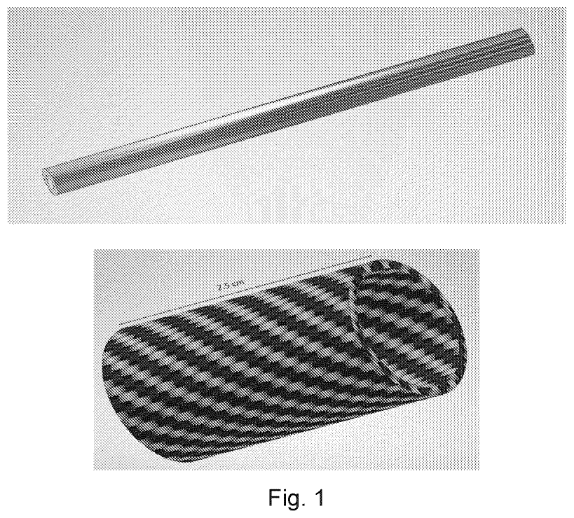

FIG. 2 is a schematic representation showing dead end sealing, permeate side sealing and the whole membrane with both sides sealed via crimping method.

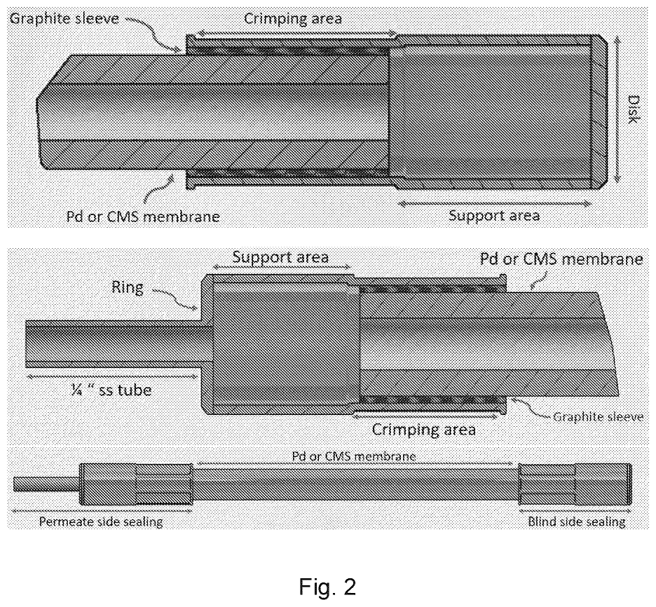

FIG. 3 shows the results of a long-term N2 permeation test for sealing stability in Pd membrane.

FIG. 4 shows pictures of the custom connectors used for the sealing and a sealed finger-like membrane.

FIG. 5 shows ideal H₂/N₂ perm-selectivities during the testing period

### DETAILS OF THE INVENTION

The sealing method according to the present invention uses crimping with a graphite intermediate layer. Crimping methods are known from industry to deform the method for liquid sealing (such as hydraulic systems), but not for inorganic membrane sealing and not for gas processes. In addition, crimping is not used in inductries on ceramic substances due to fragile nature of ceramics, and normally it is just used to seal a metalic connection on a polymeric sleeve as an intermediate layer rather than graphite.

In an embodiment of the first aspect, the method further comprises the step of sealing the metallic sleeve onto the membrane by pressing the metallic sleeve onto the membrane with the graphite sleeve in between the metallic sleeve and the inorganic membrane, to manufacture a sealed inorganic membrane. This sealing may be crimping sealing. In a specific embodiment, the sealing is performed on one or both edges of the membrane. In a specific embodiment, sealing is performed on both edges of the membrane. The pressing may performed with a hydraulic or pneumatic press. The sealed inorganic membrane may be a gas-tight seal.

In an embodiment of the first aspect, the metallic sleeve covers one or both edges of the inorganic membrane.

In an embodiment of the first aspect, the membrane has a tubular or flat geometry. In a specific embodiment, the membrane has a tubular geometry. With a ‘flat membrane’ is meant a planar membrane.

In an embodiment of the first aspect, the membrane is supported on a ceramic or metallic porous support. With ceramic is meant in the present description an inorganic, non-metallic solid, generally based on an oxide, nitride, boride, or carbide.

In an embodiment of the first aspect, the metal of the metallic sleeve is selected from the group comprising stainless steel, copper, bronze, and aluminium. In a specific embodiment, the metallic sleeve is of stainless steel.

In an embodiment of the first aspect, graphite tape with a width of between 1.0 and 5.0 cm, preferably between 2.0 and 3.0, such as 2.5 cm, is wrapped around at least one side, preferably both sides of the membrane to create a graphite sleeve. In an embodiment of the first aspect, the thickness of the tape is between 1.0 mm and 5.0 mm. In a specific embodiment the graphite tape has a width of between 1.0 and 5.0 cm, preferably between 2.0 and 3.0, such as 2.5 cm, and the thickness of the tape is between 1.0 mm and 5.0 mm, such as 1.0 mm. The length of the tape may be any length, such as between 5 and 8 cm, for example 6.5 cm.

In an embodiment of the first aspect, the provided metallic sleeve is pre-treated by a method comprising the following steps:
cutting of the metal sleeve into sections such as to a length of 2.0-8.0 cm, preferably 3.0-5.0 cm,
optionally polishing of the sections to remove sharp edges,
welding the sections to a metallic disk or to a ring,
welding the disk or ring with said sections to a metallic tube, and
attaching a metal block steel to the sections.

In a specific embodiment, the metal block is from stainless steel. In a specific embodiment, attacking of the metal block to the sections is performed using a computer numerical control (CNC) machine. In a specific embodiment, the pre-treatment method further comprises the step of 3D printing of metal alloys to the metal block that is attached to the sections.

When the inorganic membrane is tubular, the outer diameter of the sections may for example be 19.05 mm, and the inner diameter 16.65 mm. The disk may have for example an outer diameter of 19.05 mm. The ring may have for example an outer diameter of 19.05 mm and an inner diameter of ¼ inch. The metallic tube may have for example an outer diameter of ¼ inch. The welding of said disk or ring with said sections to the metallic tube may be as a permeate line with a length of 3.0 cm.

The sections are welded to a metallic disk in case of blinding of one side of the membrane. The sections are welded to ring in case of permeation purposes.

In an embodiment of the first aspect, sections of the membrane are cleaned prior to application of graphite tape onto these sections. In a specific embodiment the cleaning takes place using solvents such alcohol, preferably isopropanol.

Possible applications for the sealed inorganic membrane according to the invention are for palladium alloys; carbon membranes for H₂ separation and recovery, for CO₂ separation and utilization, for pervaporation or for vapor permeation; for methane steam reforming membranes, for catalytic hydrogenation of CO₂, or for N₂ rejection in waste gas streams in steel mill plants, dehydration processes such as bioethanol dehydration, methanol synthesis from syngas with carbon membranes.

### EFFECTS OF THE INVENTION

The sealing method according to the invention will be applicable in sealing of inorganic membranes with variety of geometries and materials. The graphite and metallic sleeve can be tuned according to the membrane geometry and size (e.g. outer diameter). The mismatch in the thermal expansion coefficient of the sealant and the membrane material is minimized via the graphite sleeve between the metallic sleeve and the membrane, allowing the membrane to operate at temperatures up to 750° C. In oxygen containing environments, the sealing could be used up to 300° C. within oxygen concentration of 21% and lower, as an application for oxygen separation membrane processes.

The sealed inorganic membrane according to the invention can pass gas permeation tests with N₂, He and H₂ up to 750° C., oxygen separation from with air up to 180° C., pressure tests up to 50 bar, and long-term tests up to 480 hr.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. The scope of the present invention is defined by the appended claims. One or more of the objects of the invention are achieved by the appended claims.

### EXAMPLES

The present invention is further elucidated based on the Examples below which are illustrative only and not considered limiting to the present invention.

### Sealing Procedure

The steps in the sealing are explained below with an example of sealing an Alumina supported Pd membrane with an Outer Diameter (OD) of 14 m. In this example, the inorganic membranes are tubular

### Preparation of Metal Sleeves

The sealing starts with preparing of the metallic sleeves for the tubular membranes. The membranes could be sealed with this method with Standard Deviation (SD) of 6% from the metallic sleeve designed inner diameter. The sealing is not sensitive to the existing standard deviation in the membranes and the produced metallic sleeves could be used regardless of their standard deviation in their outer diameter.

The process is continued with cutting the tubes with a length of 5 cm from a metallic tube, in this example stainless steel, having an outer diameter of 19.05 mm and an inner diameter of 16.65 mm. Then both sides of the tube will be polished to remove the sharp edges which could scratch the membrane during the sealing. In the next step, the 5 cm long tubes depending on the case that if they are used for a blinding of one side of the membrane or for permeation purpose, will be welded to a metallic disk with an outer diameter of 19.05 mm or to a ring with outer diameter of 19.05 mm and ID of ¼″ respectively. Finally, the ring is welded to a ¼″ outer diameter metallic tube as a permeate line with a length of 3 cm.

### Preparation of Pd or CMSM

Both Pd and CMSM are cleaned with isopropanol before the sealing to remove any dust from their surface on both end of the membrane for a length of 5 cm each side. Then a graphite tape with a diameter of 2.5 cm, length of 6.5 cm and a thickness of 1 mm is wrapped around both sides of the membrane to create a graphite sleeve with 2.5 cm from the ends of the membrane.

### Crimping

In the crimping step, first the crimping machine (Finn-power, 20 HPL) with dial crimping diameter control and a die set of 16 size and 8 dies with a press force of 1370 KN is used to press the metallic sleeve on the graphite sleeve on the membrane. The process starts with setting the diameter control of the machine to 2.4 mm which indicates the difference between the minimum crimping diameter with a 16-size die set (16 mm). As a result, the machine will allow you to crimp the connection till reaching to the outer diameter of 18.4 mm. The inner diameter of the metallic sleeve is then 15.6 mm and the graphite layer thickness after the crimping is 0.8 mm.

In the next step, one side of the membrane, which is ready for crimping, is marked with a marker for a 2.5 cm length measuring from the membrane inserting side of the metallic sleeve. This is due to the wideness of the graphite tape. The membrane with a prepared end is then inserted in the crimping machine and only 2.5 cm of the sleeve, which is containing graphite tape under it, will be crimped according to the marked sign. Finally, the crimping is started by pumping a hydraulic press to reach the desired diameter of crimping which the LED indicator on the machine will inform. The same process is then applied to the other side of the membrane to seal the stainless steel sleeve to the membrane.

### Helium Leakage Test

The sealed inorganic membrane can then be tested for gas tightness of the seal. This can be done by after the crimping, removing the membrane from the machine and connecting it to a mass flow meter of helium (He) for a leakage test while inserted in ethanol bath. He is injected inside of the membrane with a pressure of 2 bar and in case of no bubbles appearing around the sealings, the sealing considered successful. In case of existing bubbles from the joints, the crimping can be repeated with lowering the setting of the dial of the crimping machine to 2.2 mm instead of 2.4 mm.

### N₂ Permeation Test

The quality of the sealing can also be tested by an N₂ permeation test. This is done by testing the membrane in the reactor with high temperatures and pressures. The process starts with connection of the sealed membrane to membrane reactor and injection of the N₂ gas to the reactor. The permeate stream of the membrane has been measured via an automatic bubble flow meter (Horiba SEC VP1) which can measure the flowrate from 0.2 to 10 ml/min. To see the effect of aging in the sealing, the N₂ permeation test carried out for 96 h. Table 1 is indicating the N₂ permeation test on the sealing for a Pd membrane:

TABLE 1
N₂ permeance vs. applied pressure difference in Pd membrane

| | N₂ permeance (mol. | | |
|---|---|---|---|
| | m − 2 · s − 1 pa − 1) *E−10 | | |
| Pressure (bar) | 20° C. | 300° C. | 500° C. |
| 6 | 2.697 | 2.929 | 3.07 |
| 5 | 2.619 | 2.378 | 2.99 |
| 4 | 2.632 | 2.889 | 3.03 |
| 3 | 2.582 | 2.867 | 2.97 |
| 2 | 2.53 | 2.923 | 3.04 |
| 1 | 2.674 | 3.257 | 3.22 |

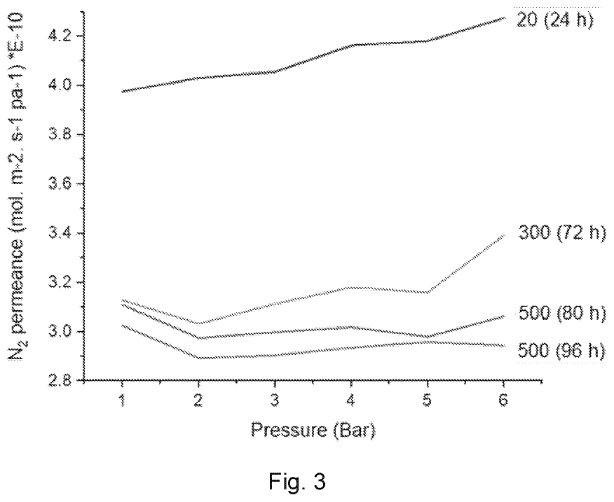

To investigate the aging effect on the Pd membrane, the long-term test has been carried out on the membrane. As indicated by FIG. 3, the sealing was stable for 96 h at 500° C. and could be used in this example for H₂ separation via Pd membranes or CMSMs.

### Sealing of Hydrogen Selective Membranes

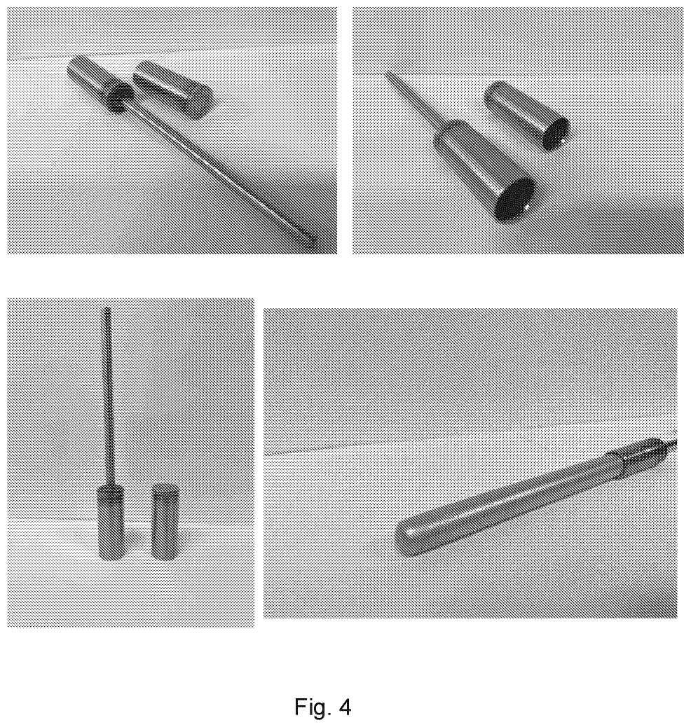

Custom sealing connectors are used to make the novel membrane sealing. In FIG. 4, pictures of the custom connectors and a sealed membrane are shown.

The novel membrane sealing was applied to a 437 mm long finger-like DS-PdAg membrane of 14/7 OD/ID. The leakage of the membrane was measured at different pressures and temperatures to assess the temperature resistance of the novel sealing. In Error! Reference source not found.2, results of these leakage measurements can be seen. Higher pressure results in higher leakage since the driving force increases with pressure. Also, a slightly increasing trend of N₂ leakage can be observed with increasing temperature. This could be either explained by the temperature dependency of the transport mechanism of the leakage or small defects in the PdAg layer that open up due to the higher temperature. Before and after the tests, the membrane was pressurized with Helium and emersed in ethanol to see the locations of the major leakages. No leakage from the sealing was observed, both before and after the high temperature tests.

TABLE 2
Table with leakage from the complete membrane including
sealing at different pressures and temperatures

N2 leakage (mln/min)

| Temp. Δp | 20° C. | 300° C. | 500° C. | 20° C. repeat |
|---|---|---|---|---|
| 6 bar | 4.388 | 4.764 | 4.995 | 9.228 |
| 5 bar | 3.550 | 3.224 | 4.056 | 7.970 |
| 4 bar | 2.854 | 3.133 | 3.288 | 5.761 |
| 3 bar | 2.100 | 2.332 | 2.419 | 4.521 |
| 2 bar | 1.372 | 1.585 | 1.650 | 2.865 |
| 1 bar | 0.725 | 0.883 | 0.874 | 1.480 |

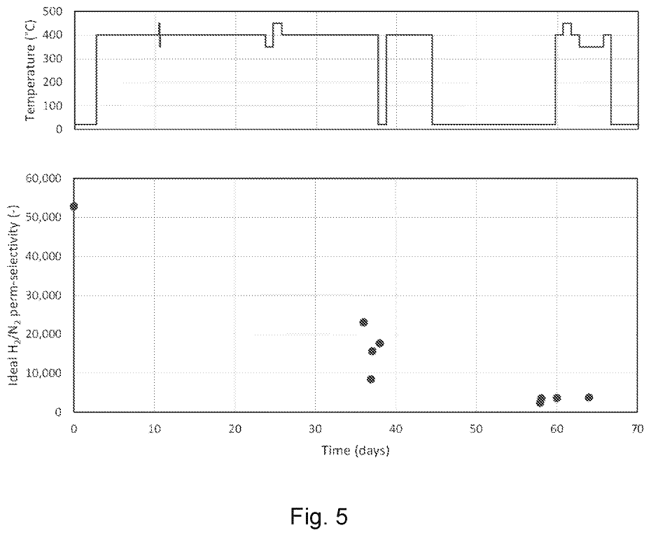

A conventional finger-like PdAg membrane of 467 mm long was sealed using the novel membrane sealing. The membrane was then used for extensive testing in H₂—N₂conditions at 350-450° C. and 1-5 bar(a), the permeate side of the membrane was operated at vacuum pressure. In FIG. 5, the monitored ideal H₂/N₂ perm-selectivity is shown against the timeline of the testing period. It can be seen that the selectivity drops over time, this drop of selectivity is most likely a result of the formation of defects on the membrane surface. After the membrane tests, the membrane was pressurized with helium and immersed in ethanol, only a small leak from the sealing was observed but this was only a minor contribution compared to the leakage from the membrane surface.

The sealing has been also used in membrane reactors for ammonia decomposition and hydrogen production. The table below shows extremely high selectivities even after ammonia decomposition reaction, showing that the sealing can be used for ultrapure hydrogen production and does not deteriorate at high temperatures and in the presence of ammonia. The table relates to a Pd/Ag-Arenha-4 membrane, with a thickness of the Pd layer of 6-8 μm.

TABLE 3
Perm-selectivities of the Pd based membranes with the new sealing

| Temperature | ΔP | H2 permeance | N2 permeance | H2/N2 ideal |
|---|---|---|---|---|
| [° C.] | [bar] | [mol/s/m2/Pa] | [mol/s/m2/Pa] | perm-selectivity |
| 425 | 1 | 1.15E−06 | 1.80E−11 | 63967 |
| | 2 | 1.08E−06 | 1.05E−11 | 102924 |
| | 3 | 1.01E−06 | 8.01E−12 | 126250 |
| | 4 | 9.74E−07 | 6.76E−12 | 144019 |
| | 5 | 9.29E−07 | 6.01E−12 | 154530 |
| 450 | 1 | 1.22E−06 | 1.70E−11 | 71888 |
| | 2 | 1.12E−06 | 1.00E−11 | 112110 |
| | 3 | 1.08E−06 | 7.68E−12 | 140522 |
| | 4 | 1.03E−06 | 6.51E−12 | 157715 |
| | 5 | 9.90E−07 | 5.81E−12 | 170307 |
| 475 | 1 | 1.26E−06 | 1.60E−11 | 78906 |
| | 2 | 1.19E−06 | 9.02E−12 | 131861 |
| | 3 | 1.12E−06 | 7.01E−12 | 159676 |
| | 4 | 1.07E−06 | 6.01E−12 | 178013 |
| | 5 | 1.03E−06 | 5.41E−12 | 190778 |
| 500 | 1 | 1.35E−06 | 1.50E−11 | 89553 |
| | 2 | 1.23E−06 | 9.02E−12 | 136350 |
| | 3 | 1.15E−06 | 7.01E−12 | 164486 |
| | 4 | 1.11E−06 | 5.76E−12 | 192339 |
| | 5 | 1.07E−06 | 5.21E−12 | 205885 |

1-15. (canceled)

16. A sealing method for the sealing of a metal sleeve to an inorganic membrane, the method comprising the steps of:
providing a metallic sleeve configured to cover at least part of the inorganic membrane; and
applying graphite tape onto at least part of the inorganic membrane to create a graphite sleeve in between the inorganic membrane and the metallic sleeve.

17. The method according to claim 16, further comprising the step of:
sealing the metallic sleeve onto the membrane by pressing the metallic sleeve onto the membrane with the graphite sleeve in between the metallic sleeve and the inorganic membrane, to produce a sealed inorganic membrane.

18. The method according to claim 17, wherein the sealing is performed on at least one edge of the inorganic membrane.

19. The method according to claim 17, wherein the pressing is performed using a hydraulic press or a pneumatic press.

20. The method according to claim 17, wherein the sealed inorganic membrane provides a gas-tight seal.

21. The method according to claim 16, wherein the metallic sleeve covers at least one edge of the inorganic membrane.

22. The method according to claim 16, wherein the inorganic membrane has a tubular geometry of a flat geometry.

23. The method according to claim 16, wherein the inorganic membrane is supported on a ceramic porous support or a metallic porous support.

24. The method according to claim 16, wherein the metal of the metallic sleeve is selected from the group including stainless steel, copper, bronze, and aluminum.

25. The method according to claim 16, wherein the graphite tape has a width between 1.0 cm and 5.0 cm, and wherein the graphite tape is wrapped around at least one side of the inorganic membrane.

26. The method according to claim 16, wherein a thickness of the graphite tape is between 1.0 mm and 5.0 mm.

27. The method according to claim 16, wherein the metallic sleeve is pre-treated by a method comprising the steps of:
cutting the metal sleeve into sections having a length between 3.0 cm and 5.0 cm;
optionally polishing the sections to remove sharp edges;
welding the sections to a metallic disk or to a ring;
welding the metallic disk or ring with the attached sections to a metallic tube; and
attaching a metal block to the sections using a computer numerical control machine.

28. The method according to claim 27, wherein the pre-treatment method further comprises the step of 3D printing metal alloys to the metal block that is attached to the sections.

29. The method according to claim 16, further comprising the step of using the sealed inorganic membrane in a membrane reactor or as a membrane reactor for a gas separation process for the separation of at least two gases, wherein the gases including at least one of He, H₂O, Ne, H₂, NO, Ar, NH₃, N₂, O₂, CO, CO₂, CH₄, C₂H₄, C₂H₆, propene, propane, H₂S, methanol, ethanol, DME, 1-2 propanol, and 1-2 butanol.
